(19) United States
(12) Patent Application Publication
(10) Pub. No.: US 2009/0323134 A1
(43) Pub. Date: Dec. 31, 2009

(54) APPARATUS AND METHOD FOR GENERATING SEGMENTATION DATA OF A SCANNED IMAGE

(75) Inventor: Shunichi Megawa, Shizouka-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 12/164,763

(22) Filed: Jun. 30, 2008

(51) Int. Cl. H04N 1/04; G06K 9/34

(52) U.S. Cl. 358/474; 382/180

(57) ABSTRACT

An apparatus and method for processing image data generates image data from a scan of an original image, and creates segmentation data from the generated image data. The segmentation data includes information regarding image types present in the image data corresponding to the scanned original image. Each of the image data and the segmentation data is stored in a storage medium along with a link between the image data and the segmentation data.

### FIELD OF THE INVENTION

The present invention relates generally to image processing and, more particularly, to a system and method for generating segmentation data of a scanned image.

### BACKGROUND OF THE INVENTION

When a user requests an image file to be printed, the hardcopy device doing the printing typically performs several image processing functions such as filtering and halftoning. The hardcopy device, which can be a printer, multi-function peripheral (MFP) or other device capable of generating a hardcopy of an image file, may be configured to perform segmentation analysis of the image data of the image file. The segmentation analysis, sometimes referred to as layout analysis, identifies image types for different regions of the image data. Image types include, for example, photo, text, graph, and table. Information from the segmentation analysis may be used to identify how to perform other image processing functions before printing the image data.

Although the information from the segmentation analysis can be useful when performing image processing functions and thus improve the quality of the printed image, the performance of the segmentation analysis can be time consuming. As a result, the process of printing the image file can take a long time. To speed up the printing process, the segmentation analysis can be skipped, but this results in a degraded printed image.

Accordingly, when printing an image file, it would be desirable to take advantage of the benefit derived from performing the segmentation analysis without demonstrably delaying the printing process.

### SUMMARY OF THE INVENTION

According to an aspect of the invention, an image forming apparatus and method for processing image data generates image data from a scan of an original image, and creates segmentation data from the generated image data. The segmentation data includes information regarding image types present in the image data corresponding to the scanned original image. Each of the image data and the segmentation data is stored in a storage medium along with a link between the image data and the segmentation data.

Further features, aspects and advantages of the present invention will become apparent from the detailed description of preferred embodiments that follows, when considered together with the accompanying figures of drawing.

### BRIEF DESCRIPTION OF THE DRAWINGS

FIG. 1 is a block diagram of an image processing system consistent with the present invention.

FIG. 2 is a flow diagram of a process for generating segmentation data of a scanned image consistent with the present invention.

FIG. 3 is a flow diagram of a print process consistent with the present invention.

### DETAILED DESCRIPTION OF PREFERRED EMBODIMENTS

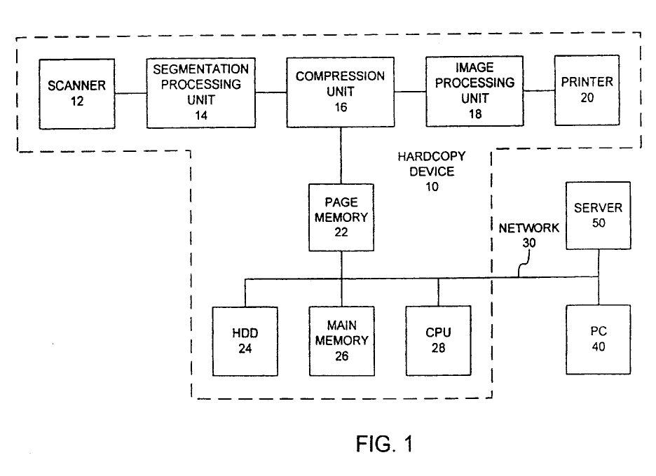

FIG. 1 is a block diagram of an image processing system consistent with the present invention. As shown in FIG. 1, the image processing system includes a hardcopy device 10, a PC 40, and a server 50. The hardcopy device 10, the PC 40, and the server 50 are all coupled together by a network 30. The network may be a local network, such as a LAN, or a public network, such as the Internet.

The hardcopy device 10 is a device that can generate a reproduction of an electronic document, such as a printer, a multi-function peripheral (MFP), or any other functional device that is capable of generating hardcopies of documents or files. The hardcopy device 10 may be color or monochrome (i.e., black and white), laser or inkjet type, and provide various finishing options, such as stapling or hole-punching.

The PC 40, which may be a workstation or a server, includes a CPU, a main memory, a ROM, a storage device and a communication interface all coupled together via a bus in one embodiment consistent with the present invention. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

The communication interface for the PC 40 provides a two-way data communication coupling via a network link to the network 30. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information, to and from the network 30.

If the network 30 is implemented as the Internet, the PC 40 can transmit a requested code for an application program through the Internet, an ISP, the local network and the communication interface. The received code can be executed by the CPU in the workstation or server as it is received, stored in the storage device, or stored in some other non-volatile storage for later execution. In this manner, a user at the workstation or server may obtain application code in the form of a carrier wave. The server 50 may be implemented in the same manner as the workstation 10, plus any other functionality that may be needed to manage the operation of the network 30.

In operation, the PC 40 communicates with the hardcopy device 10 via the network 30 or via a more direction connection, such as by USB. This communication enables the PC 40 to request the hardcopy device 10 to perform a function, such as print a document or send or receive a fax. In addition, the PC 40 can request information from the hardcopy device 10.

As further shown in FIG. 1, the hardcopy device 10 includes a scanner 12, a segmentation processing unit 14, a compression unit 16, an image processing unit 18, a printer 20, a page memory 22, a hard disk drive (HDD) 24, a main memory 26, and a CPU 28. The scanner 12 scans original images from documents placed on a document table of the hardcopy device 10. The documents can be placed on the document table, which is typically a glass plate, with an automatic document feeder (ADF) or by hand. The scanner 12 includes a light source, such as a lamp, that scans light across the document. The light reflected by the document is directed to a light detecting sensor, which converts the detected light into digital image data. The light detecting sensor can be implemented as a charge-coupled device (CCD).

The segmentation processing unit 14 receives the image data from the scanner 12 and performs segmentation processing on the image data. Segmentation processing, which may also be referred to as layout processing, divides the image data into different regions depending upon the type of image present in that region. For example, the original document may have text regions, graphics regions, table regions and/or photographic regions. The process for segmenting image data into identifiable regions is well known to one skilled in the art. For example, U.S. Pat. No. 5,687,252 to Hiroki Kanno, the entire contents of which are incorporated by reference, describes an exemplary segmenting process that may be carried out by the segmentation processing unit 14. Japanese Publication No. 2003-087562, the entire contents of which are incorporated by reference, describes another segmenting process that may be carried out by the segmentation processing unit 14. By performing the segmentation processing, the segmentation processing unit 14 generates information identifying the image types present in the image data and the corresponding locations of those image types within the image data. The segmentation processing unit 14 can be implemented in hardware, in software, or in some combination thereof. As described in more detail herein, the segmentation data can be used to optimize the compression and image processing functions performed on the image data. The present embodiment is not limited to any particular form of segmentation processing.

The compression unit 16 receives the image data of the scanned original image and the segmentation data output from the segmentation processing unit 14. The compression unit 16 is configured to compress the image data of the scanned original image, as well as to decompress image data that has already been compressed as required. The compression unit 16 can also be configured to compress the segmentation data. However, since the segmentation data may have a simple format and small data size, it may be unnecessary to compress the segmentation data. When compressing the image data, the compression unit 16 preferably compresses each region of the image data according to a compression algorithm appropriate for the image type of the region as identified by the segmentation data. For example, the compression unit 16 can use a high resolution compression algorithm, like MMR, for a text region, and a low resolution compression algorithm, like JPEG, for a photo region.

The compressed image data and the segmentation data is provided to the page memory 22, which provides the compressed image data and the segmentation data to a storage area. If the segmentation data itself is not compressed, the segmentation data can be provided to the page memory 22 from the segmentation processing unit 14 directly (or through the compression unit 16 without any compressing). The page memory 22 can be implemented as a temporary storage element or buffer, and preferably has a size sufficient to store the image data of at least one page of an original image.

The compressed image data and the segmentation data are preferably stored in the HDD 24. If the hardcopy device 10 is implemented as an MFP, then the HDD 24 is typically referred to as a box. Alternatively, the compressed image data and the segmentation data can be stored in another storage area that can be either present in the hardcopy device 10 or in another device coupled to the hardcopy device 10 through the network 30, such as the server 50, the PC 40, a file server or some other storage medium.

The compressed image data and the segmentation data are preferably stored in separate files, with the compressed image data being stored in a file suitable for storing image data and the segmentation data being stored in a file suitable for storing segmentation data. The files are preferably stored with a link or connection between them so that the two files are associated with each other. For example, both files may have the same name, but with different tags such as .tif and .txt for the compressed image data and the segmentation data, respectively. The common file names provide a link between them. Alternatively, the files for the compressed image data and the segmentation data can be stored with a table that identifies, or provides information regarding, the link between compressed image data and the segmentation data, as well as the links of any other compressed image data and the segmentation data. The link is any form of information or electronic mechanism for associating the two files.

The main memory 26 includes programming, instructions, and data used by the CPU 28 to control the functions of the hardcopy device 10. The main memory 26 can include RAM providing an operable memory area used by the hardcopy device 10, as well as non-volatile storage, such as ROMs or flash memory, that store the programming, instructions, and data loaded to the RAM.

When it comes time to print the image data, the compressed image data (and the segmentation data if it has been compressed) is decompressed by the compression unit 16 and provided with the segmentation data to the image processing unit 18. The image processing unit 18 can perform one or more image processing functions including, for example, image data conversion, gamma correction, density adjustment, range compensation, halftone processing, dithering, error diffusion, smoothing, filtering, enlargement/reduction or other image processing functions. Using the segmentation data, the image processing unit 18 can be configured to optimize the use of image processing functions according to the image types of each region of the image data. For example, the image processing unit 18 may be configured to perform one set of functions for a first image type region, such as a text region, and perform a second set of functions different than the first set of functions for a photo region or other type of region. By way of example and not by way of limitation, a first set of functions that uses graphics information, and a second set of functions that uses text information stored in a table, can be utilized as image processing functions that can be performed for different image type regions. The image processing unit can also be configured to perform a particular image processing function in a first manner for a text region, but perform that same image processing function in a different manner for a different region type.

The processed image data from the image processing unit 18 is provided to the printer 20 to reproduce the scanned original image. The reproduction can be formed on any type of media to which toner can be fixed, such as a standard paper sheet, a paper having a surface coating, or overhead transparency sheets. The printer 20 can include an ink source, such as a developer or ink, an image generating unit for generating a latent image from the processed image data, an image transfer unit for transferring the latent image to the copy paper and a fusing unit for fusing the image to the image receiving medium.

In the design of FIG. 1, it should be understood that one or more elements in the hardcopy device 10 may be implemented outside of the hardcopy device 10. For example, the segmentation processing unit 14 and compression unit 16 could be implemented in a device coupled to the hardcopy device 10, such as the server 50, the PC 40, or other device. In operation, the image data output from the scanner 12 can be provided outside the hardcopy device 10 to the segmentation processing unit 14 and the compression unit 16 via the network 30. If the hardcopy device 10 is a printer or copier, then the scanner 12 may be implemented as a scanning unit coupled to the hardcopy device 10. In addition, the segmentation unit 14, the compression unit 16, and the image processing unit 18 can be implemented as a single unit, either within the hardcopy device 10 or in a device coupled to the hardcopy device 10. These elements can be implemented in hardware, in software, or in some combination thereof.

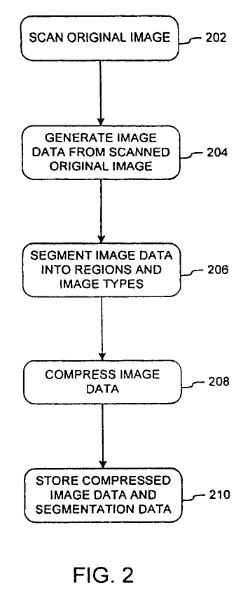

FIG. 2 is a flow diagram of a process for generating segmentation data of a scanned image consistent with the present invention. As shown in FIG. 2, a user scans an original image (step 202). The original image may be in color or black and white and is preferably scanned by the scanner 12, although another scanning unit independent of the hardcopy device 10 can also be used to scan the original image. As a result of the scan, the scanner 12 generates image data (step 204). Depending upon the implementation of the scanner 12, the image data may be formatted as RGB data or as black and white data. In particular, if the scanner 12 includes color sensors, then the image data can be formatted as RGB data, and if the scanner only includes a black and white sensor, then the image data can be formatted as black and white data.

The segmentation processing unit 14 segments the generated image data into regions and image types (step 206). As described above, the segmentation processing unit 14 divides the image data into different regions depending upon the type of image present in that region. For example, the original document may have text regions, graphics regions, table regions and/or photographic regions. More specifically, the segmentation processing unit 14 generates information identifying the image types present in the image data and the corresponding locations of those image types within the image data. This information corresponds to segmentation data, which can be formatted in a simple text format and output from the segmentation processing unit.

In addition to undergoing segmentation processing, the compression unit 16 compresses the image data (step 208). As described above, the compression unit 16 can also compress the segmentation data as desired. To perform the compression, the compression unit 16 preferably compresses each region of the image data according to a compression algorithm appropriate for the image type of the region as identified by the segmentation data. For example, the compression unit 16 can use a high resolution compression algorithm, like MMR, for a text region, and a low resolution compression algorithm, like JPEG, for a photo region.

The compressed image data and the segmentation data are stored in a storage area (step 210). More particularly, the compressed image data and the segmentation data are stored in the HDD 24 or some other non-volatile storage area either within the hardcopy device 10 or coupled to the hardcopy device 10 by the network 30. The compressed image data and the segmentation data can be stored in the same storage medium or in different storage mediums. The compressed image data and the segmentation data are preferably stored as separate files in the storage area with a link or connection between them so that the two files are associated with each other. For example, as described above, both files may have the same name, but with different tags such as .tif and .txt for the compressed image data and the segmentation data, respectively. Alternatively, the storage area can include a table that identifies the link between compressed image data and the segmentation data, and well as the links of any other compressed image data and the segmentation data. In this manner, the image data can be printed at a later time at the discretion of the user, and the segmentation data is already generated and available to be used when reproducing the image data.

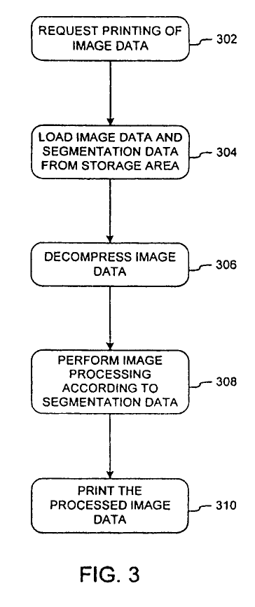

FIG. 3 is a flow diagram of a print process consistent with the present invention. In particular, a user first makes a request to print the image data. (step 302). The user can make the request through an interface of the hardcopy device 10. Alternatively, the user can make the request through an application operating on the PC 40, the server 50, or other device coupled by the network 30 to the hardcopy device 10. The print request is preferably received by an application operating on the hardcopy device 10.

In response to the print request, the hardcopy device 10 loads the image data and the segmentation data from the storage area (304). The print request preferably includes at least an identifier of the file storing the image data. The hardcopy device 10 uses this identifier and locates the link between the file storing the image data and the file storing the segmentation data. Using the link, the hardcopy device 10 is able to locate the files for the image data and the associated segmentation data and load the data files from the applicable location. In addition to loading the data files, the compression unit 16 decompresses the image data (step 306). If the image data has been compressed with more than one compression algorithms according to the image type of each region, then the compression unit 16 decompresses each region of the image data using the corresponding decompression algorithm. If the segmentation data has also been compressed, then the compression unit 16 also decompresses the segmentation data. As seen, the prior segmentation processing has already been done, ahead of the print request. It does not have to be carried out after the print request is made.

The image processing unit 18 performs one or more image processing functions on the image data according to the segmentation data (step 308). As described above, the image processing functions including, for example, image data conversion, gamma correction, density adjustment, range compensation, halftone processing, dithering, error diffusion, smoothing, filtering, enlargement/reduction or other image processing functions. The image processing unit 18 preferably uses the segmentation data to optimize the use of image processing functions according to the image types of each region of the image data. For example, the image processing unit 18 may use some image processing functions for one image type, but different ones for others. In addition, a particular image processing function may be altered or optimized for each region type.

The printer 20 prints the processed image data output from the image processing unit 18 (step 310). The printer 20 can reproduce the processed image data in accordance with any parameters set in the print request. For example, the print request may include settings for particular finishing parameters, single or double sided printing, or color or monochrome printing.

In this manner, the process for printing image data can use the segmentation data to optimize the image processing of the image data. By previously determining and storing the segmentation data, the image data can be printed without the delay resulting from performing the segmentation processing. Furthermore, by performing the segmentation processing and saving the segmentation data before performing compression of the image data, the segmentation data used for image processing is based on non-distorted image data and is therefore more accurate, as opposed to performing segmentation processing on distorted image data resulting from the decompression of the compressed image data.

The foregoing description of preferred embodiments of the invention has been presented for purposes of illustration and description. It is not intended to be exhaustive or to limit the invention to the precise form disclosed, and modifications and variations are possible in light in the above teachings or may be acquired from practice of the invention. The embodiments (which can be practiced separately or in combination) were chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for processing image data, comprising:
generating image data from a scan of an original image;
creating segmentation data from the generated image data, the segmentation data including information regarding image types present in the image data corresponding to the scanned original image; and
storing each of the image data and the segmentation data in a storage medium, and providing a link between the image data and the segmentation data.

2. A method according to claim 1, wherein the step of storing includes:
generating a first file for the image data;
generating a second file, different from the first file, for the segmentation data; and
storing the first file and the second file in the storage medium,
wherein the link includes information associating the first file with the second file.

3. A method according to claim 2, wherein the steps of generating the first file and generating the second file further include:
providing a common file name to the first file and the second file; and
providing a different suffix to the first file and the second file.

4. A method according to claim 2, wherein the first file and the second file have different formats.

5. A method according to claim 1, wherein the segmentation data includes information identifying an image type for each of a plurality of regions of the image data.

6. A method according to claim 5, further comprising compressing the image data prior to storing the image data in the storage medium.

7. A method according to claim 6, wherein the step of compressing includes:
compressing a first region of the plurality of regions of the image data identified as a first type according to a first compression algorithm; and
compressing a second region of the plurality of regions of the image data identified as a second type, different from the first type, according to a second compression algorithm, different from the first compression algorithm.

8. A method according to claim 6, wherein the step of compressing further includes:
determining image type for each of the plurality of regions of the image data based on the segmentation data;
identifying a compression algorithm for each of the plurality of regions of the image data according to its determined image type; and
compressing each of the plurality of regions of the image data according to its identified compression algorithm.

9. A method according to claim 6, where the step of compressing further includes compressing the segmentation data.

10. A method according to claim 5, wherein the identified image type is one of text, photo, table, or graph.

11. A method according to claim 1, further comprising:
receiving a request to print the image data;
loading the image data and the segmentation data from the storage medium;
processing the image data based on the segmentation data; and
printing the processed image data.

12. A method according to claim 11, further comprising decompressing the loaded image data.

13. A method according to claim 11, wherein the step of processing the image data includes:
applying one or more image processing functions to a first image type region of the image data; and
applying one or more image processing functions to a second image type region, different than the first image type region, of the image data,
wherein at least one of the one or more image processing functions applied to the second image type region of the image data is not applied to the first image type region.

14. A method according to claim 1, wherein the step of storing the image data and the segmentation data includes:
storing the image data in a first storage medium; and
storing the segmentation data in a second storage medium, different from the first storage medium.

15. A method according to claim 1, further comprising generating a table that identifies the link between the image data and the segmentation data.

16. A method for processing image data, comprising:
generating image data from a scan of an original image;
creating segmentation data from the generated image data, the segmentation data including information regarding image types present in the image data corresponding to the scanned original image;
compressing the image data; and
storing the compressed image data and the segmentation data in a storage medium.

17. An apparatus for processing image data, comprising:
a scanner that generates image data from a scan of an original image;
a segmentation unit that creates segmentation data from the generated image data, the segmentation data including information regarding image types present in the image data corresponding to the scanned original image; and
a storage medium that stores each of the image data and the segmentation data and stores a link between the image data and the segmentation data.

18. An apparatus according to claim 17, wherein the segmentation data includes information identifying an image type for each of a plurality of regions of the image data.

19. An apparatus according to claim 18, further comprising a compression unit that compresses the image data before the image data is stored in the storage medium.

20. An apparatus according to claim 17, further comprising:
an image processing unit that performs one or more image processing functions on the image data based on the segmentation data in response to receiving a request to print the image data; and
a printer that prints the processed image data.
